(19) United States
(12) Patent Application Publication
(10) Pub. No.: US 2007/0133996 A1
(43) Pub. Date: Jun. 14, 2007

(54) Transmitter

(76) Inventor: Toshihisa Kyouno, Kawasaki (JP)

Correspondence Address: BINGHAM MCCUTCHEN LLP, 2020 K Street, N.W., Intellectual Property Department, WASHINGTON, DC, 20006, US

(21) Appl. No.: 11/363,184

(22) Filed: Feb. 28, 2006

(30) Foreign Application Priority Data
Nov. 29, 2005 (JP) 2005-344502

(51) Int. Cl. H04B 10/00

(52) U.S. Cl. 398/140; 370/510; 370/514; 370/518; 370/324; 725/129

(57) ABSTRACT

A transmitter transmits digital terrestrial wave information related to a digital terrestrial broadcast by using a communication system of Wave Division Multiplexing (WDM). The transmitter calculates a synchronizing difference, which is a difference between a reference signal and a synchronizing signal synchronizing with the lead of each image picture contained in image data of the digital terrestrial wave information, and transmits calculated synchronizing difference and the digital terrestrial wave information to a transmission destination.

### BACKGROUND OF THE INVENTION

1. Field of the Invention

The present invention relates to a transmitter that transmits digital terrestrial wave information related to digital terrestrial broadcasts by a communication system based on Wave Division Multiplexing (WDM).

2. Description of the Related Art

Recently, to promote high definition and intelligent functions of television, digital terrestrial broadcast services have been started in some towns. Such a service includes transmitting digitized signals for terrestrial television broadcasts from a radio wave tower to each broadcasting station. For example, similar service has been started in Tokyo by transmitting digitized signals from Tokyo Tower.

Currently it is common to transmit the digitized signals by wireless transmission. A conventional technique has been disclosed, for example, in Tomohito Ikegami, et al., “Digital Terrestrial Television Transmitter System in Tokyo Tower”, NEC Technical Journal Vol. 57, No. 4/2004, pp. 49-54.

However, because wireless systems are recently used for various applications as well as the digital terrestrial broadcasts, frequencies of such wireless systems are antagonizing one another. Therefore, there is strong need for provision of a signal transmission system via cable for the digital terrestrial broadcasts.

However, it is very difficult to transmit signals via cable for the digital terrestrial broadcasts. The reason being that, interfaces of various devices used in such system are generally based on very sophisticated specifications.

One approach is to lay down new cables dedicated for the digital terrestrial broadcasts. However, this approach is expensive and therefore unrealistic.

Therefore, there is a need of a technology that enables transmission of digital terrestrial broadcasts via existing general-purpose cables.

### SUMMARY OF THE INVENTION

It is an object of the present invention to at least solve the problems in the conventional technology.

According to an aspect of the present invention, a transmitter that transmits digital terrestrial wave information related to a digital terrestrial broadcast by using a communication system of Wave Division Multiplexing (WDM), includes a synchronizing signal difference calculating unit that calculates a synchronizing difference, which is a difference between a reference signal and a synchronizing signal synchronizing with the lead of each image picture contained in image data of the digital terrestrial wave information; and a transmitting unit that transmits calculated synchronizing difference and the digital terrestrial wave information to a transmission destination.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a transmitting system according to a first embodiment of the present invention;

FIG. 2 depicts detailed functional block diagrams of a transmitter and an add/drop multiplexer shown in FIG. 1;

FIG. 3 is a detailed functional block diagram of configuration of a transmission processing unit shown in FIG. 2;

FIG. 4 is a schematic for explaining extraction of a difference between a broadcasting TS synchronizing signal and an 8K synchronizing signal;

FIG. 5 is a schematic for explaining extraction of a difference between a synchronizing clock signal and an 8K synchronizing signal;

FIG. 6 is a schematic for explaining data structure of a frame to be mapped by a virtual concatenation 3 mapping processing unit shown in FIG. 2;

FIG. 7 is a detailed functional block diagram of a reception processing unit shown in FIG. 2;

FIG. 8 is a schematic for explaining reproduction of a broadcasting TS synchronizing signal;

FIG. 9 is a schematic for explaining reproduction of a synchronizing clock;

FIG. 10 is a schematic of a transmitting system according to a second embodiment of the present invention;

FIG. 11 is a detailed functional block diagram a transmitter and a wavelength multiplexer shown in FIG. 10;

FIG. 12 is a detailed functional block diagram of a transmission processing unit shown in FIG. 11;

FIG. 13 is a detailed functional block diagram of a signal mapping unit shown in FIG. 11;

FIG. 14 is a schematic for explaining data structure of a control signal;

FIG. 15 is a detailed functional block diagram of a signal demapping unit shown in FIG. 11; and

FIG. 16 is a detailed functional block diagram of a reception processing unit shown in FIG. 11.

### DETAILED DESCRIPTION OF THE PREFERRED EMBODIMENTS

Exemplary embodiments of the present invention are explained below in detail with reference to the accompanying drawings.

A transmitter according to a first embodiment of the present invention calculates a difference between a reference synchronizing signal used in a communication system of Synchronous Optical NETwork (SONET)/Synchronous Digital Hierarchy (SDH) and a signal contained in a digital terrestrial broadcast, embeds the difference and the signal corresponding to the digital terrestrial broadcast into a frame (such as a SONET/SDH frame), and transmits the frame to a target transmitter.

The target transmitter receives the frame, extracts the difference and the signal corresponding to the digital terrestrial broadcast from the frame, and reproduces the original digital terrestrial broadcast based on the extracted data.

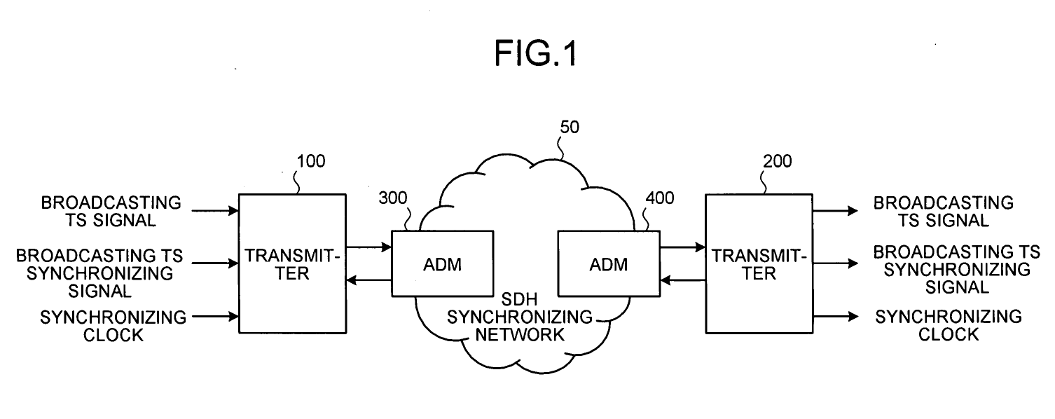

FIG. 1 is a schematic of a transmitting system according to the first embodiment. In the transmitting system according to the first embodiment, a transmitter 100 is connected to a Add/Drop Multiplexer (ADM) 300 and a transmitter 200 is connected to a Add/Drop Multiplexer (ADM) 400. The ADMs 300 and 400 are connected each other via a SDH synchronizing network 50.

The transmitter 100 calculates a difference between a signal contained in a digital terrestrial broadcast and a reference synchronizing signal, and transmits the difference and the signal corresponding to the digital terrestrial broadcast to the transmitter 200 via the ADMs 300 and 400. The transmitter 200 receives the difference and the signal corresponding to the digital terrestrial broadcast from the transmitter 100, and reproduces a signal corresponding to the signal of the digital terrestrial broadcast.

The digital terrestrial broadcast includes a broadcasting Transport Stream (TS) signal, a broadcasting TS synchronizing signal, and a synchronizing clock. The broadcasting TS signal is an image data signal related to the digital terrestrial broadcast, the broadcasting TS synchronizing signal is a signal synchronizing with the starting point of each image picture contained in the broadcasting TS signal, and the synchronizing clock is a signal to be used when signals of the digital terrestrial wave information are received and produced at a transmission destination.

The ADM 300 embeds information acquired from the transmitter 100 into a frame, and transmits the frame to the ADM 400 via the SDH synchronizing network 50. If the ADM 300 receives such a frame, the ADM 300 extracts information contained in the frame, and passes the information to the transmitter 100. The ADM 300 passes a reference synchronizing signal received from outside to the transmitter 100.

Configuration of the transmitter 100 and the ADM 300 shown in FIG. 1 is explained. Explanation about configuration of the transmitter 200 and the ADM 400 is omitted because it is similar to that of the transmitter 100 and the ADM 300.

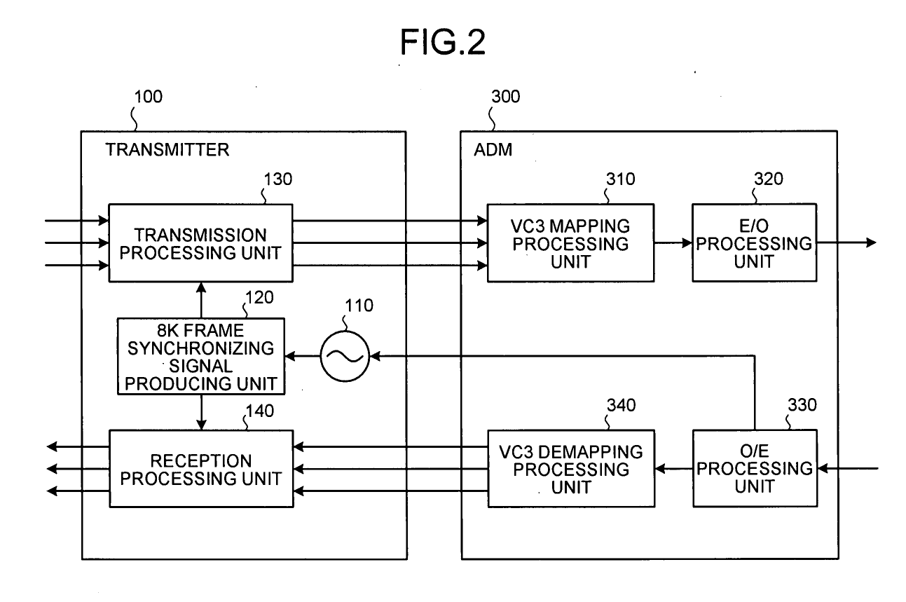

FIG. 2 depicts detailed functional block diagrams of the transmitter 100 and the ADM 300. The transmitter 100 includes a Phase Locked Loop (PLL) 110, an 8K (i.e., 8 KHz) frame synchronizing signal producing unit 120, a transmission processing unit 130, and a reception processing unit 140. The ADM 300 includes a Virtual Concatenation 3 (VC3) mapping processing unit 310, an electrooptical (E/O) processing unit 320, an optoelectric (O/E) processing unit 330, and a VC3 demapping processing unit 340.

The PLL 110 matches the frequency of an input signal to the frequency of an output signal. Namely, the PLL 110 passes the reference synchronizing signal input from the ADM 300 to the 8K frame synchronizing signal producing unit 120 with no change in frequency.

The 8K frame synchronizing signal producing unit 120 produces a reference synchronizing signal at the frequency of 8 KHz (hereinafter, “8K synchronizing signal”) based on the reference synchronizing signal, and passes the 8K synchronizing signal to the transmission processing unit 130 and the reception processing unit 140.

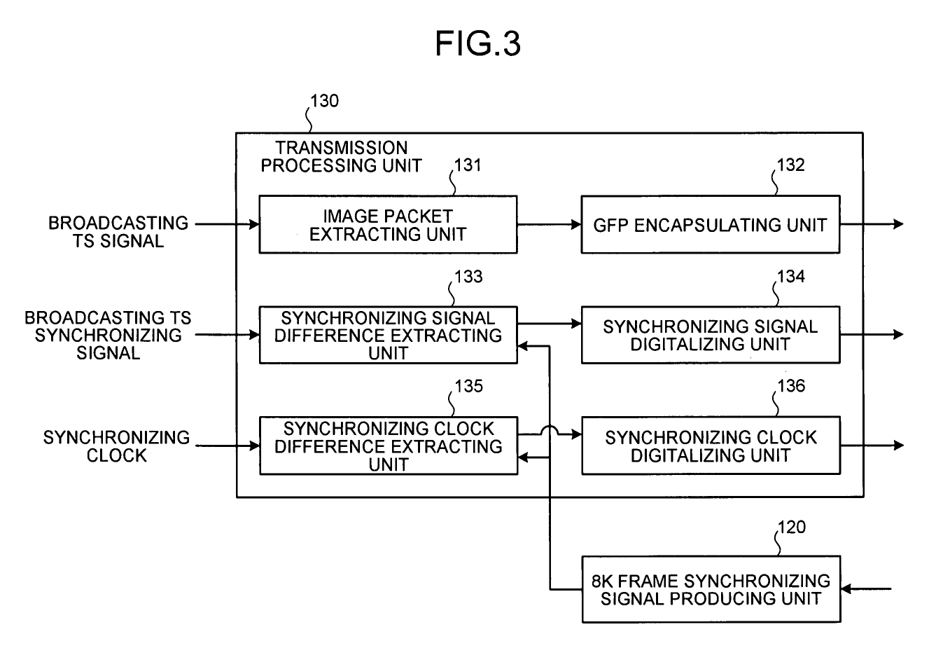

FIG. 3 is a detailed functional block diagram of the transmission processing unit 130. The transmission processing unit 130 includes an image packet extracting unit 131, a Generic Framing Procedure (GFP) encapsulating unit 132, a synchronizing signal difference extracting unit 133, a synchronizing signal digitizing unit 134, a synchronizing clock difference extracting unit 135, and a synchronizing clock digitizing unit 136.

The image packet extracting unit 131 extracts image packets contained in the broadcasting TS signal, and passes the extracted image packets to the GFP encapsulating unit 132. The GFP encapsulating unit 132 encapsulates the image packets using the GFP encapsulating method, and passes the encapsulated image packets (hereinafter, “encapsulated image data”) to the ADM 300.

The synchronizing signal difference extracting unit 133 acquires the broadcasting TS synchronizing signal and the 8K synchronizing signal, calculates a difference between the two signals, and passes difference information indicative of the difference to the synchronizing signal digitizing unit 134. The synchronizing signal digitizing unit 134 digitizes the difference information, passes the digitized difference information (hereinafter, “synchronizing difference value information”) to the ADM 300.

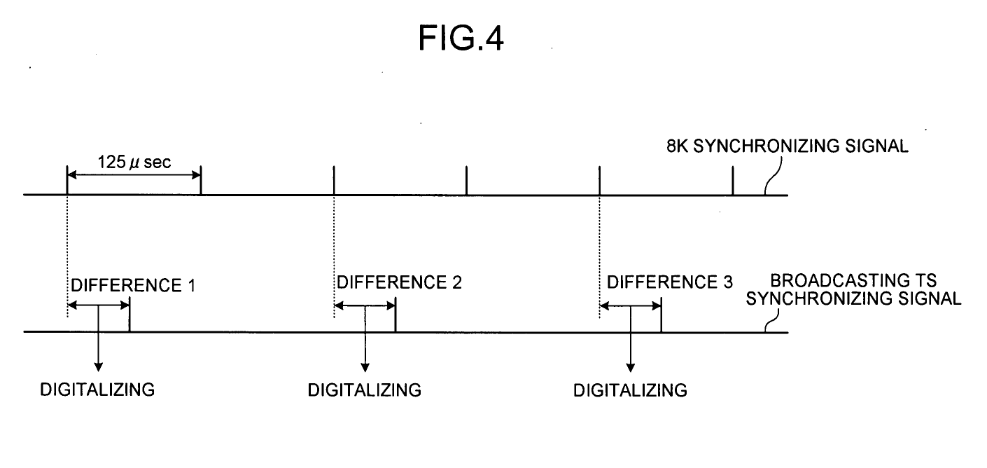

FIG. 4 is a schematic for explaining extraction of a difference between the broadcasting TS synchronizing signal and the 8K synchronizing signal. At a time point when a rising edge of an 8K synchronizing signal with a 125-microsecond cycle is detected, a counter circuit (not shown) is made to start counting time based on a prespecified high frequency, and the time counting is continued until the broadcasting TS synchronizing signal is completely booted. When the broadcasting TS synchronizing signal is completely booted, the time counting is stopped, and the value indicative of the counted time is determined as synchronizing difference value information. If no rising edge of a broadcasting TS synchronizing signal is detected during a 125-microsecond cycle of the 8K synchronizing signal, it is transferred that there is no synchronizing difference value information, as presence-absence information of broadcasting TS synchronizing signal difference. This can be observed by a method of detecting the next booting of another 8K synchronizing signal during the counter operation, or by a method of detecting reset of the counter to restart counting when a rising edge of another 8K synchronizing signal is detected during the counter operation.

Turning back to the explanation of FIG. 3, the synchronizing clock difference extracting unit 135 acquires the synchronizing clock and the 8K synchronizing signal, extracts a difference between the two signals, and passes difference information indicative of the difference to the synchronizing clock digitizing unit 136. The synchronizing clock digitizing unit 136 digitizes the difference information, passes the digitized difference information (hereinafter, “clock difference value information”) to the ADM 300.

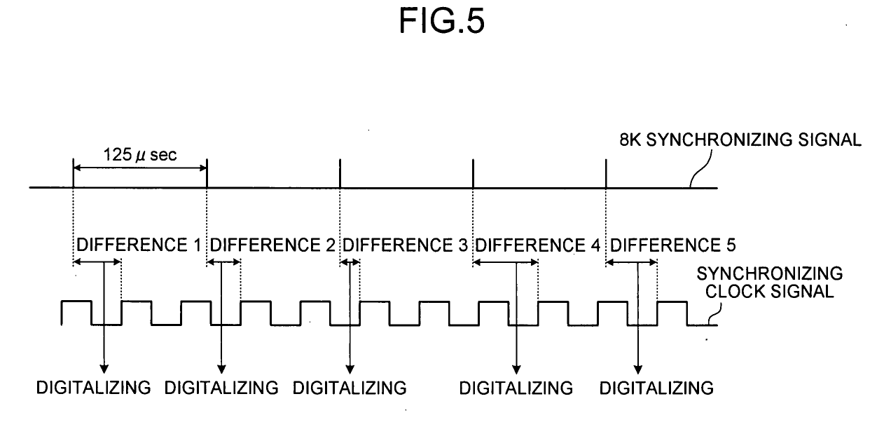

FIG. 5 is a schematic for explaining extraction of a difference between the synchronizing clock signal and the 8K synchronizing signal. At a time point when a rising edge of an 8K synchronizing signal with a 125-microsecond cycle is detected, a counter circuit (not shown) is made to start counting time based on a prespecified high frequency, and the time counting is continued until a first synchronizing clock signal is completely booted. When the synchronizing clock signal is completely booted, the time counting is stopped, and a value indicative of the counted time is determined as clock difference value information. If no rising edge of a synchronizing clock signal is detected during the 125-microsecond cycle of the 8K synchronizing signal, it is transferred that there is no clock difference value information, as presence-absence information of synchronizing clock difference signal. This can be observed by a method of detecting the next booting of another 8K synchronizing signal during the counter operation, or by a method of detecting reset of the counter to restart counting when the next booting of another 8K synchronizing signal is detected during the counter operation.

Turning back to the explanation of FIG. 2, the VC3 mapping processing unit 310 acquires encapsulated image data, synchronizing difference value information, and clock difference value information from the transmission processing unit 130, and maps the acquired information into a frame. GFP is used as a method of mapping into frame.

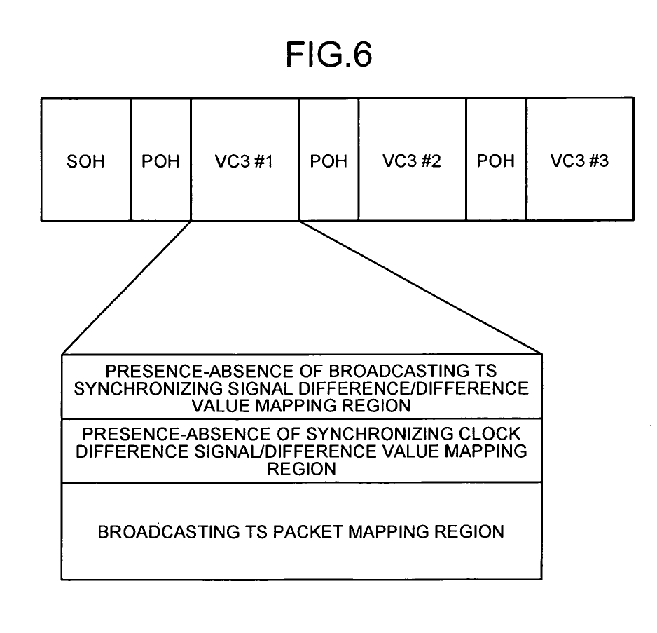

FIG. 6 is a schematic for explaining data structure of a frame mapped by the VC3 mapping processing unit 310. The frame includes Section Overhead (SOH), Path Overhead (POH), VC3 #1, VC3 #2 and VC3 #3. Each of VC3 #1, VC3 #2, and VC3 #3 includes a presence-absence of broadcasting TS synchronizing signal difference/difference value mapping region, a presence-absence of synchronizing clock difference signal/difference value mapping region, and a broadcasting TS packet mapping region.

The SOH is a region to store information necessary for maintenance operation, such as transmission line shift information, and POH is a region to store operation control information per unit section. The presence-absence of broadcasting TS synchronizing signal difference/difference value mapping region is a region to store synchronizing difference value information (for the presence-absence of broadcasting TS synchronizing signal difference/difference value mapping region, a region of 16 bit is reserved, where a counter value is inserted as is in binary number code). When there is no synchronizing difference value information, the presence-absence of broadcasting TS synchronizing signal difference/difference value mapping region stores information that there is no difference between the broadcasting TS synchronizing signal and the 8K synchronizing signal.

The presence-absence of synchronizing clock difference signal/difference value mapping region is a region to store clock difference value information (for the presence-absence of synchronizing clock difference signal/difference value mapping region, a region of 16 bit is reserved, where a counter value is inserted as is in binary number code). When there is no clock difference value information, the presence-absence of synchronizing clock difference signal/difference value mapping region stores information that there is no difference between the synchronizing clock and the 8K synchronizing signal. The broadcasting TS packet mapping region is a region to store encapsulated image data.

Turning back to explanation of FIG. 2, the E/O processing unit 320 converts received electric frame, which includes an electrical signal, into a optical frame, which includes optical signal, and transmits the optical frame to the ADM 400 via the SDH synchronizing network 50.

When the O/E processing unit 330 receives such an optical frame via the SDH synchronizing network 50, the O/E processing unit 330 converts the optical frame into an electric frame, and passes the electric frame to the VC3 demapping processing unit 340. When the O/E processing unit 330 receives a reference synchronizing signal, the O/E processing unit 330 passes the reference synchronizing signal to the PLL 110.

The VC3 demapping processing unit 340 acquires the frame from the O/E processing unit 330, extracts encapsulated image data, synchronizing difference value information, and clock difference value information from an acquired frame, and also passes extracted information to the reception processing unit 140.

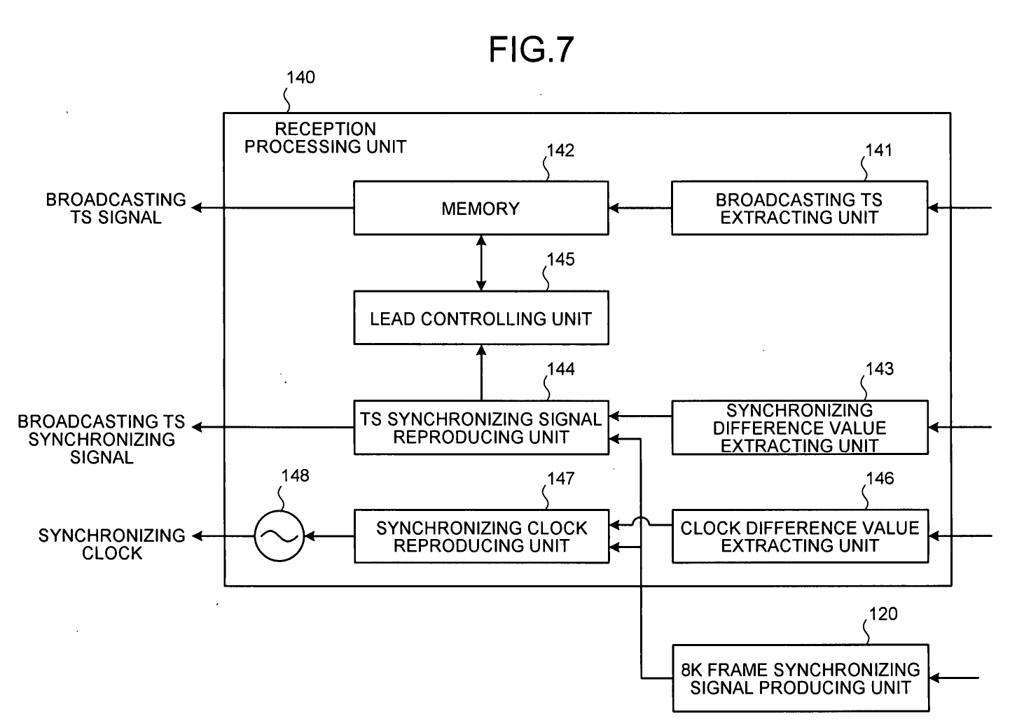

FIG. 7 is a detailed functional block diagram of the reception processing unit 140. The reception processing unit 140 includes a broadcasting TS extracting unit 141, a memory 142, a synchronizing difference value extracting unit 143, a TS synchronizing signal reproducing unit 144, a lead controlling unit 145, a clock difference value extracting unit 146, a synchronizing clock reproducing unit 147, and a PLL 148.

The broadcasting TS extracting unit 141 acquires the encapsulated image data from the ADM 300, extracts image packet(s) from an acquired encapsulated image data, and stores the image packet(s) into the memory 142.

The synchronizing difference value extracting unit 143 acquires the synchronizing difference value information from the ADM 300, extracts the synchronizing difference value from an acquired synchronizing difference value information, and passes the extracted synchronizing difference value to the TS synchronizing signal reproducing unit 144.

The TS synchronizing signal reproducing unit 144 acquires the synchronizing difference value and the 8K synchronizing signal from the synchronizing difference value extracting unit 143 and the 8K frame synchronizing signal producing unit 120 respectively, and reproduces a broadcasting TS synchronizing signal corresponding to that transmitted from a transmission source based on the acquired each information.

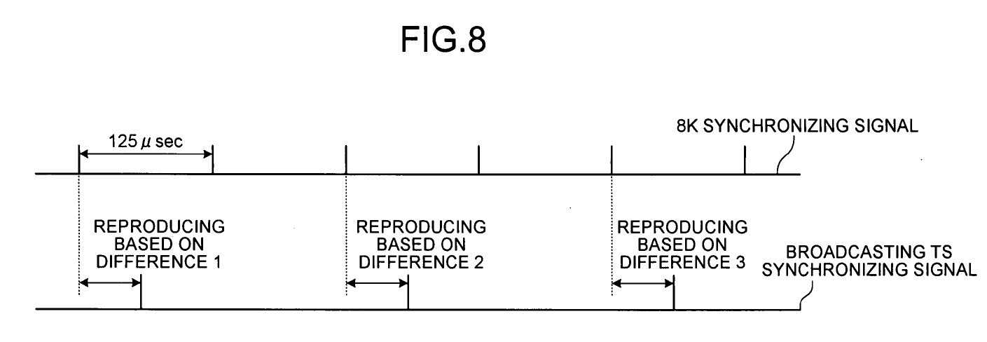

FIG. 8 is a schematic for explaining reproduction of a broadcasting TS synchronizing signal. From a time point when a rising edge of an 8K synchronizing signal is detected, the counter is made to start counting time, and a time point at which the time counted by the counter reaches the synchronizing difference value is determined as the booting point of a broadcasting TS synchronizing signal. By repeating such processes, the TS synchronizing signal reproducing unit 144 reproduces a broadcasting TS synchronizing signal. The TS synchronizing signal reproducing unit 144 passes the reproduced broadcasting TS synchronizing signal to the lead controlling unit 145 and a host computer (not shown).

Turning back to the explanation of FIG. 7, the lead controlling unit 145 passes image packets stored in the memory 142 to the host computer. The lead controlling unit 145 controls a flow of image packets to the host computer so that the lead image packet in each image picture configured with a plurality of image packets is synchronized with the broadcasting TS synchronizing signal passed from the TS synchronizing signal reproducing unit 144.

The clock difference value extracting unit 146 acquires clock difference value information from the ADM 300, extracts a clock difference value from acquired clock difference value information, and passes the clock difference value to the synchronizing clock reproducing unit 147.

The synchronizing clock reproducing unit 147 acquires the clock difference value and the 8K synchronizing signal from the clock difference value extracting unit 146 and the 8K frame synchronizing signal producing unit 120 respectively, and reproduces a synchronizing clock corresponding to that in the transmission source based on each of acquired information.

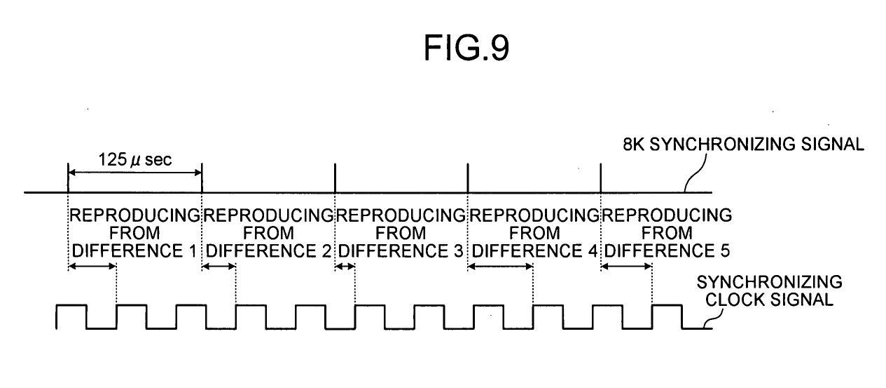

FIG. 9 is a schematic for explaining reproduction of a synchronizing clock. At a time point when a rising edge of an 8K synchronizing signal is detected, the counter is made to count time, and a time point at which the time counted by the counter reaches the clock difference value is determined as the booting point of a synchronizing clock. By repeating such processes, the synchronizing clock reproducing unit 147 reproduces a synchronizing clock. The synchronizing clock reproducing unit 147 transmits a reproduced synchronizing clock to the host computer via the PLL 148. Because the PLL 148 is similar to the PLL 110 shown in FIG. 2, its explanation is omitted.

Thus, the transmitter 100 transmits the GFP encapsulating unit 132, the synchronizing signal digitizing unit 134, and the synchronizing clock digitizing unit 136 produce encapsulated image data, synchronizing difference value information, and clock difference value information to the transmitter 200 via the ADM 300.

Furthermore, when the transmitter 100 receives a frame, the broadcasting TS extracting unit 141 extracts a broadcasting TS signal, the TS synchronizing signal reproducing unit 144 reproduces a broadcasting TS synchronizing signal, and the synchronizing clock reproducing unit 147 reproduces a synchronizing clock, so that signal transmission via cable for digital terrestrial broadcast(s) can be easily attained at station by station of broadcasting through existing general lines.

The transmitter 100 and the ADM 300 have been shown as separate units in FIG. 2, however, the transmitter 100 can be configured to include the ADM 300.

A transmitter according to a second embodiment of the present invention calculates a difference value between a reference synchronizing signal in the own transmitter and a signal related to a digital terrestrial broadcast, and transmits a computed difference value and the signal of the digital terrestrial broadcast to destination(s) by a communication system of Wave Division Multiplexing (WDM).

A transmitter, which then receives a difference value and a signal of a digital terrestrial broadcast from another transmitter by the WDM communication system, based on the difference value and the signal of the digital terrestrial broadcast reproduces a signal corresponding to the signal of the digital terrestrial broadcast in a transmission source.

In this way, the transmitter according to the second embodiment transmits a difference value and a signal of a digital terrestrial broadcast by the WDM communication system, and also when the transmitter receives a difference value and a signal of a digital terrestrial broadcast from another transmitter, the transmitter reproduces a signal of the digital terrestrial broadcast corresponding to the signal of the digital terrestrial broadcast in a transmission source, so that signal transmission via cable for digital terrestrial broadcast(s) can be easily attained at station by station of broadcasting through existing general lines.

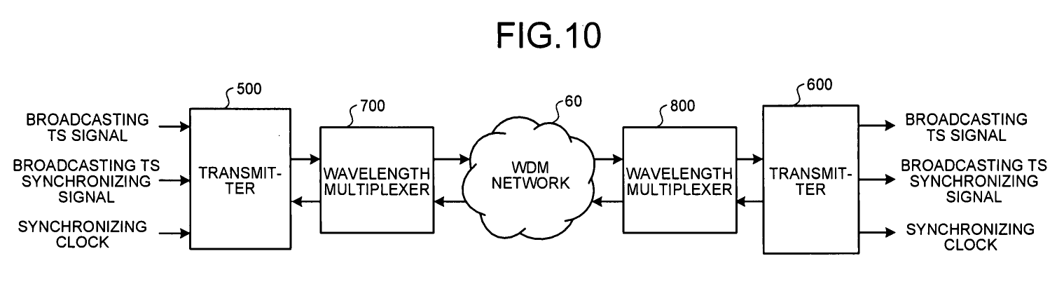

FIG. 10 is a schematic of a transmitting system according to the second embodiment. In the transmitting system according to the second embodiment, a transmitter 500 is connected to a wavelength multiplexer 700, and a transmitter 600 is connected to a wavelength multiplexer 800. The wavelength multiplexers 700 and 800 are connected each other via a WDM network 60.

The transmitter 500 calculates difference values from the reference synchronizing signal with respect to a broadcasting TS synchronizing signal and a synchronizing clock among signals related to the digital terrestrial broadcast (namely, a broadcasting TS signal, a broadcasting TS synchronizing signal, and a synchronizing clock), and transmits computed difference values and the signals of the digital terrestrial broadcast to the transmitter 600 via the wavelength multiplexers 700 and 800. When the transmitter 600 receives a signal from the transmitter 500, based on the difference values and the signal of the digital terrestrial broadcast contained in a received signal, the transmitter 600 reproduces signals corresponding to the signals of the digital terrestrial broadcast acquired for the transmitter 500 to transmit to the transmitter 600.

The wavelength multiplexer 700 acquires the difference values and the signals of the digital terrestrial broadcast from the transmitter 500, multiplexes the broadcasting TS signal related to the signals of the digital terrestrial broadcast and the difference values with respect to the broadcasting TS synchronizing signal and the synchronizing clock with wavelengths related to WDM, and transmits them to the wavelength multiplexer 800. The wavelength multiplexer 800 extracts the broadcasting TS signal and the difference values with respect to the broadcasting TS synchronizing signal and the synchronizing clock from signals acquired from the wavelength multiplexer 700, and passes extracted information to the transmitter 600.

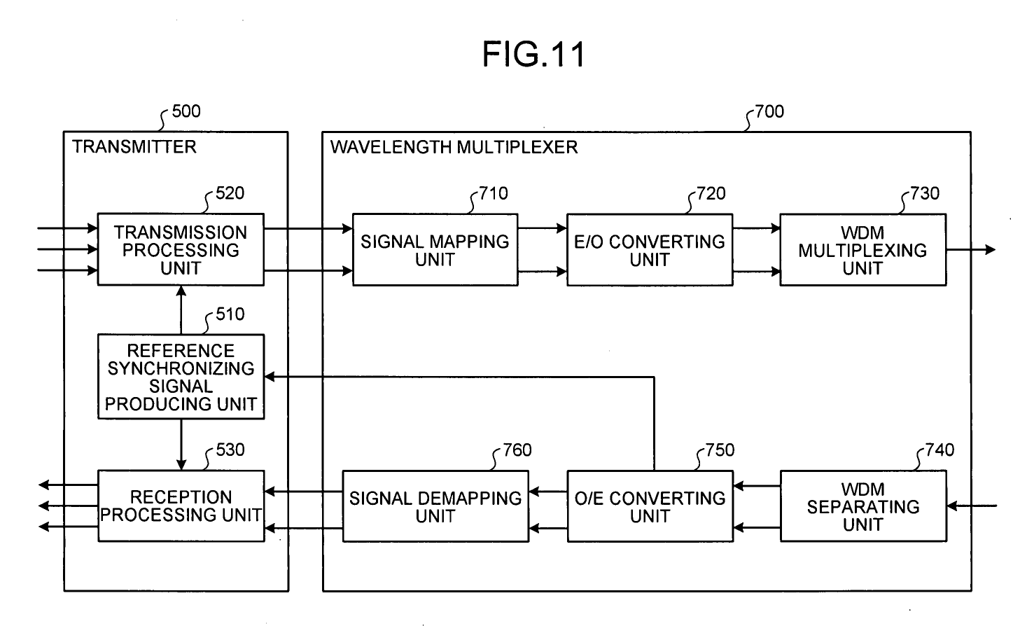

FIG. 11 is a detailed functional block diagram of the transmitter 500 and the wavelength multiplexer 700 shown in FIG. 10. Explanation about configuration of the transmitter 600 and the wavelength multiplexer 800 is omitted because it is similar to that of the transmitter 500 and the wavelength multiplexer 700.

The transmitter 500 includes a reference synchronizing signal producing unit 510, a transmission processing unit 520, and a reception processing unit 530. The wavelength multiplexer 700 includes a signal mapping unit 710, an E/O converting unit 720, a WDM multiplexing unit 730, a WDM separating unit 740, an O/E converting unit 750, and a signal demapping unit 760.

The reference synchronizing signal producing unit 510 produces a synchronizing signal that is referenced in the transmitter 500, i.e. a reference synchronizing signal. Specifically, the reference synchronizing signal producing unit 510 receives a WDM signal from the WDM network 60, extracts reference timing from a received WDM signal, and also acquires reference timing from outside.

The reference synchronizing signal producing unit 510 then selects the optimal reference timing between the reference timing from WDM signal, the reference timing acquired from outside, and own reference timing in the transmitter 500, and produces a reference synchronizing signal with selected reference timing. The reference synchronizing signal producing unit 510 passes a produced reference synchronizing signal to the transmission processing unit 520 and the reception processing unit 530.

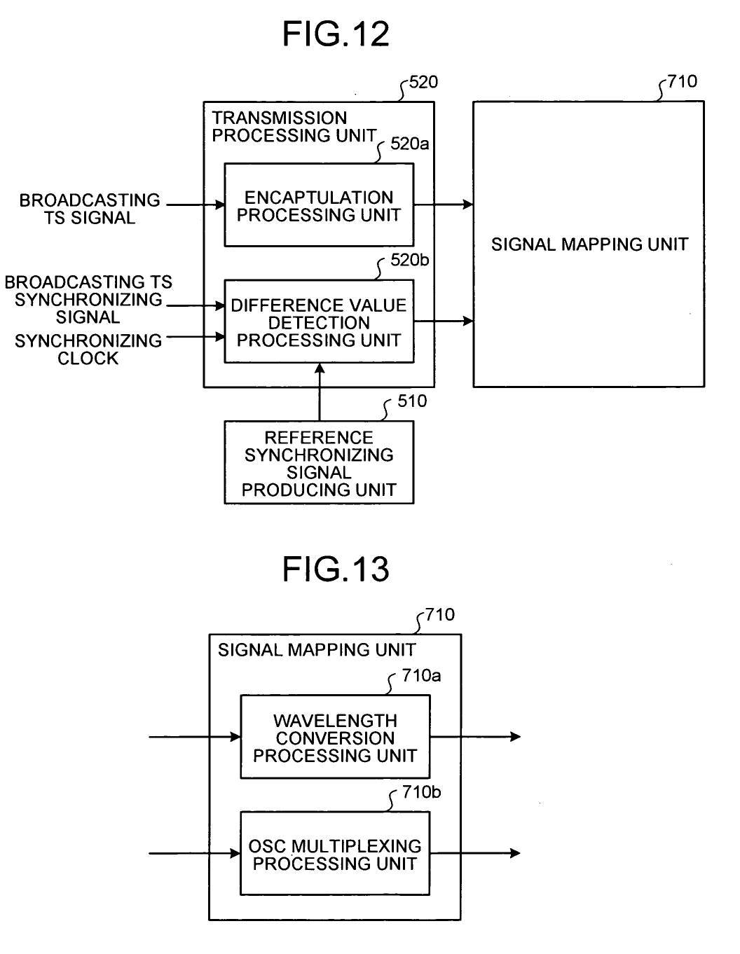

The transmission processing unit 520 acquires a broadcasting TS signal, a broadcasting TS synchronizing signal, and a synchronizing clock, computes for encapsulating processing and difference values, and passes encapsulated image data and information of the difference values to the signal mapping unit 710. FIG. 12 is a detailed functional block diagram of the transmission processing unit 520. The transmission processing unit 520 includes an encapsulation processing unit 520a and a difference value detection processing unit 520b.

The encapsulation processing unit 520a extracts image data from a broadcasting TS signal, encapsulates (for example, to encapsulate according to the GFP encapsulating method) extracted image data, and passes encapsulated image data (encapsulated image data) to the signal mapping unit 710.

The difference value detection processing unit 520b acquires a broadcasting TS synchronizing signal, a synchronizing clock and the reference synchronizing signal, and computes a difference value between the broadcasting TS synchronizing signal and the reference synchronizing signal (synchronizing difference value information) and a difference value between the synchronizing clock and the reference synchronizing signal (clock difference value information). Because a method of computing synchronizing difference value information and clock difference value information is similar to the method shown in the first embodiment, explanation is omitted. After computing the difference values, the difference value detection processing unit 520b passes the synchronizing difference value information and the clock difference value information to the signal mapping unit 710.

The signal mapping unit 710 acquires the encapsulated image data, the synchronizing difference value information, and the clock difference value information from the transmission processing unit 520, and maps acquired information in a prespecified format. FIG. 13 is a detailed functional block diagram of the signal mapping unit 710. The signal mapping unit 710 includes a wavelength conversion processing unit 710a and an OSC multiplexing processing unit 710b.

The wavelength conversion processing unit 710a acquires the encapsulated image data related to the broadcasting TS signal, maps acquired encapsulated image data in a communication format used in the WDM communication system, and also converts mapped information into wavelengths defined by the WDM communication system. The wavelength conversion processing unit 710a passes wavelength-converted encapsulated image data (referred to as WDM image data below) to the E/O converting unit 720.

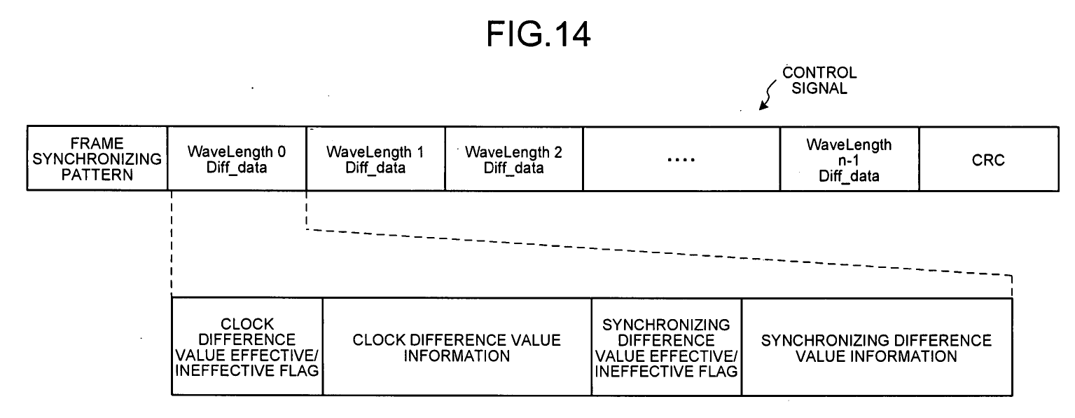

The OSC multiplexing processing unit 710b acquires the synchronizing difference value information and the clock difference value information from the transmission processing unit 520, and maps acquired information to be adapted in a format related to Optical Supervisory Channel (OSC) signals (to multiplex bite location defined by the format), and passes mapped information (referred to as control signal below) to the E/O converting unit 720. FIG. 14 is a diagram of an example of a data structure of a control signal.

As shown in FIG. 14, the control signal includes a frame synchronizing pattern, namely, WaveLength 0 Diff_data, WaveLength 1 Diff_data, WaveLength 2 Diff_data, . . . , WaveLength n−1 Diff_data, and CRC (Cyclic Redundancy Check). The WaveLength 0 Diff_data includes a clock difference value effective/ineffective flag, clock difference value information, a synchronizing difference value effective/ineffective flag, and synchronizing difference value information. Here, the clock difference value effective/ineffective flag indicates whether the clock difference value information is effective, and the synchronizing difference value effective/ineffective flag indicates whether the synchronizing difference value information is effective.

Being omitted in FIG. 14, however, each of the WaveLength 1 Diff_data, the WaveLength 2 Diff_data, and the WaveLength n−1 Diff_data also includes a clock difference value effective/ineffective flag, clock difference value information, a synchronizing difference value effective/ineffective flag, and synchronizing difference value information, similarly to the WaveLength 0 Diff_data.

Turning back to explanation of FIG. 11, the E/O converting unit 720 acquires the WDM image data and the control signal from the signal mapping unit 710, and converts acquired WDM image data and control signal with electrical signal to those with optical signal. The E/O converting unit 720 passes converted WDM image data and control signal with optical signal to the WDM multiplexing unit 730.

The WDM multiplexing unit 730 acquires the WDM image data and the control signal with optical signal from the E/O converting unit 720, and optically multiplexes acquired WDM image data and control signal. The WDM multiplexing unit 730 transmits an optically multiplexed signal via the WDM network 60 to the wavelength multiplexer 800.

When optically multiplexed WDM image data and control signal are received from the WDM network, the WDM separating unit 740 separates the optically multiplexed WDM image data and control signal. The WDM separating unit 740 passes separated WDM image data and control signal to the O/E converting unit 750.

The O/E converting unit 750 acquires the WDM image data and the control signal with optical signal from the WDM separating unit 740, and converts acquired WDM image data and control signal with optical signal into WDM image data and control signal with electrical signal. The O/E converting unit 750 passes converted WDM image data and control signal with electric signal to the signal demapping unit 760. The O/E converting unit 750 acquires reference timing of a WDM signal via the WDM separating unit 740, and passes acquired reference timing to the reference synchronizing signal producing unit 510.

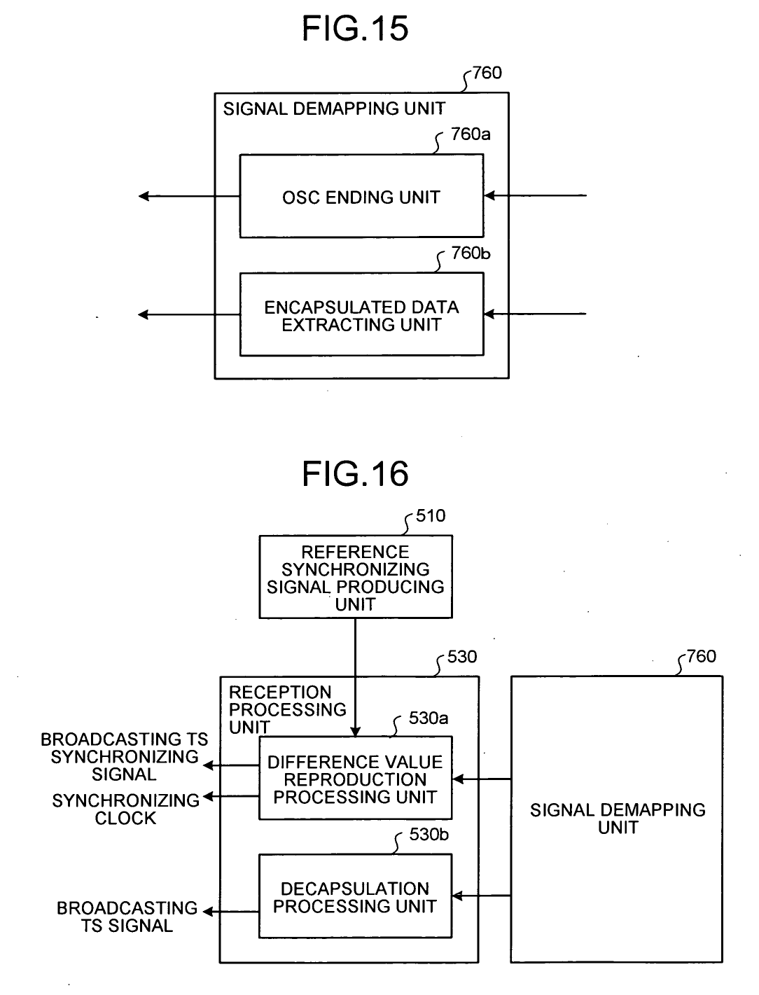

The signal demapping unit 760 acquires the WDM image data and the control signal from the O/E converting unit 750, and extracts encapsulated image data, synchronizing difference value information, and clock difference value information from acquired information. FIG. 15 is a functional block diagram of configuration of the signal demapping unit. As shown in the figure, the signal demapping unit 760 includes an OSC ending unit 760a and an encapsulated data extracting unit 760b.

The OSC ending unit 760a acquires the control signal, extracts synchronizing difference value information and clock difference value information from an acquired control signal, and passes extracted synchronizing difference value information and extracted clock difference value information to the reception processing unit 530.

The encapsulated data extracting unit 760b acquires the WDM image data, extracts encapsulated image data by demapping from the communication format defined by the WDM communication system, and passes extracted encapsulated image data to the reception processing unit 530.

The reception processing unit 530 acquires the encapsulated image data, the synchronizing difference value information, the clock difference value information, and the reference synchronizing signal, and reproduces a broadcasting TS signal, a broadcasting TS synchronizing signal, and a synchronizing clock. FIG. 16 is a functional block diagram of configuration of the reception processing unit. As shown in the figure, the reception processing unit 530 includes a difference value reproduction processing unit 530a and a decapsulation processing unit 530b.

The difference value reproduction processing unit 530a acquires the reference synchronizing signal, the synchronizing difference value information, and the clock difference value information, reproduces a broadcasting TS synchronizing signal based on the reference synchronizing signal and the synchronizing difference value information, and reproduces a synchronizing clock based on the reference synchronizing signal and the clock difference value information. Detailed explanation about reproduction of a broadcasting TS synchronizing signal and reproduction of a synchronizing clock is omitted because it is similar to that in the first embodiment.

The decapsulation processing unit 530b acquires the encapsulated image data, and extracts image data contained in acquired encapsulated image data. The decapsulation processing unit 530b then stores extracted image data into a buffer in the encapsulation processing unit 520a once, and also converts the image data into a broadcasting TS signal, by adjusting phases with the broadcasting TS synchronizing signal and the synchronizing clock that are reproduced by the difference value reproduction processing unit 530a, to reproduce the broadcasting TS signal.

With the transmitter 500 according to the second embodiment, the encapsulation processing unit 520a produces encapsulated image data, while the difference value detection processing unit 520b produces synchronizing difference value information and clock difference value information. Produced information is passed to the wavelength multiplexer 700 to be transmitted to the transmitter 600 by the WDM communication system.

Furthermore, when the wavelength multiplexer 700 receives a signal according to the WDM system, the wavelength multiplexer 700 extracts encapsulated image data, synchronizing difference value information, and clock difference value information from a received signal, and the reception processing unit 530 reproduces a broadcasting TS signal, a broadcasting TS synchronizing signal, and a synchronizing clock based on the encapsulated image data, the synchronizing difference value information, and the clock difference value information, so that signal transmission via cable for digital terrestrial broadcasts can be easily achieved at station by station of broadcasting through the existing WDM networks.

The transmitter 500 and the wavelength multiplexer 700 have been shown as separate units in FIG. 11, however the transmitter 500 can be configured to include the wavelength multiplexer 700.

According to the above embodiments, it is possible to transmit a digital terrestrial broadcast to each broadcasting station through existing general-purpose cables and without degrading the picture quality.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmitter that transmits digital terrestrial wave information related to a digital terrestrial broadcast by using a communication system of Wave Division Multiplexing (WDM), the transmitter comprising:
a synchronizing signal difference calculating unit that calculates a synchronizing difference, which is a difference between a reference signal and a synchronizing signal synchronizing with the lead of each image picture contained in image data of the digital terrestrial wave information; and
a transmitting unit that transmits calculated synchronizing difference and the digital terrestrial wave information to a transmission destination.

2. The transmitter according to claim 1, further comprising a synchronizing clock difference calculating unit that calculates a clock difference, which is a difference between the reference signal and a synchronizing clock used to receive and reproduce the digital terrestrial wave information at the transmission destination, wherein the transmitter transmits the clock difference, the synchronizing difference, and the digital terrestrial wave information to the transmission destination.

3. The transmitter according to claim 2, wherein the transmitting unit maps the synchronizing difference and the clock difference to be adapted in a format related to an Optical Supervisory Channel (OSC) signal, and transmits mapped synchronizing difference, mapped clock difference, and the digital terrestrial wave information to the transmission destination.

4. The transmitter according to claim 1, wherein the transmitting unit encapsulates the image data of the digital terrestrial wave information, allocates digital terrestrial wave information including encapsulated image data to wavelength bands related to the WDM communication system and transmits the digital terrestrial wave information to the transmission destination.

5. The transmitter according to claim 4, further comprising a image reproducing unit that reproduces image data of digital terrestrial wave information based on a received synchronizing difference, a received clock difference, and the reference signal when a signal containing the digital terrestrial wave information, the synchronizing difference, and the clock difference is received.

6. The transmitter according to claim 5, wherein the image reproducing unit further includes
an extracting unit that extracts the encapsulated image data;
a synchronizing signal producing unit that produces a synchronizing signal corresponding to a synchronizing signal in a transmission source based on the synchronizing difference and the reference signal; and
a synchronizing clock producing unit that produces a synchronizing clock corresponding to a synchronizing clock in the transmission source based on the clock difference and the reference signal.

7. The transmitter according to claim 2, wherein the transmitting unit allocates the digital terrestrial wave information, the synchronizing difference, and the clock difference to wavelength bands related to the WDM communication system to transmit the digital terrestrial wave information, the synchronizing difference, and the clock difference to the transmission destination.

8. The transmitter according to claim 7, further comprising
an information extracting unit that extracts the digital terrestrial wave information, the synchronizing difference, and the clock difference allocated to wavelength bands related to the WDM communication system, when the digital terrestrial wave information, the synchronizing difference, and the clock difference are acquired by the WDM communication system; and
an reception processing unit that produces a synchronizing difference and a clock difference corresponding to those in the transmission source based extracted synchronizing difference, clock difference, and the reference signal, and reproduces image data of the digital terrestrial wave information based on produced synchronizing difference and clock difference.
